(19) United States
(12) Patent Application Publication
(10) Pub. No.: US 2017/0332034 A1
(43) Pub. Date: Nov. 16, 2017

(54) CONTENT DISPLAY

(71) Applicant: Hewlett-Packard Development Company, L.P., Houston, TX (US)

(72) Inventors: Valentin POPESCU, Tomball, TX (US); Syed S. AZAM, Tomball, TX (US)

(21) Appl. No.: 15/513,525

(22) PCT Filed: Sep. 26, 2014
(86) PCT No.: PCT/US2014/057796

§ 371 Date: Mar. 22, 2017

(51) Int. Cl. H04N 5/445; H04N 21/41; H04N 21/462; H04N 21/439; H04N 21/4402; H04N 21/4363

(52) U.S. Cl. CPC H04N 5/445; H04N 21/4622; H04N 21/4394; H04N 21/4126; H04N 21/43635; H04N 21/4402

(57) ABSTRACT

According to an example, to output content to a display, content from a first source and a second source, via a radio, is received. The first content and the second content are combined on a processor into a single stream and output to a display. In an example, the second content is received from a server and combined with the first content in response to a user in proximity to the display. In an example, the received second content is modified in response to a change in the user proximity.

### BACKGROUND

Users of technological devices and services may own or use a number of devices and may use or subscribe to a number of services, each of which may generate or communicate content and/or data to a user. As more devices and services come online, such as with the growth of the Internet of Things, more content is being generated and communicated to users, and displayed in various form factors.

### BRIEF DESCRIPTION OF THE DRAWINGS

FIG. 1 illustrates a schematic representation of a device for receiving and combining content to be output to a display, according to an example of the present disclosure;

FIG. 2 illustrates the device of FIG. 1 when connected to a display, according to an example of the present disclosure;

FIG. 3 illustrates a flow of content from a content source to displays, according to an example of the present disclosure;

FIG. 4 illustrates a flow of a display sensing a user proximity, according to an example of the present disclosure;

FIG. 5 illustrates a flow of a server receiving and transmitting content, according to an example of the present disclosure; and

FIG. 6 illustrates a flow of receiving and combining content on a device, according to an example of the present disclosure.

### DETAILED DESCRIPTION

With the proliferation of data and content generated by technology devices and services, in combination with content generated by content providers such as television and other multimedia content providers, users of devices and services are presented with the challenge of managing the amount of content that is to be presented to them. In addition, providers of content face the challenge of reaching the user in a location where the user is located at any given time.

For example, a user who is home may receive content, such as a text message, on a mobile device that is not close to the user at any given moment, but the user may be in close proximity to a display, such as a television display or automobile display at that time. Similarly, a user who is traveling, for example in an airport, may not have ready access to the user's mobile device to receive a push notification of a flight change, but may be in close proximity to a display managed by the airport or airline.

In such examples, a user may wish to receive content on the closest display as opposed to a mobile device or other device associated with the user, either when the user comes into proximity or when a user approaches a display and requests to use or “take over” the display. In some examples, the user may want to control the display of private information in such a manner.

Users may wish, however, to ensure that any content from a second source, e.g., a text message or push notification, does not obscure a primary content source on the display, such as a television feed at home or an airport map in an airport, or may wish to avoid switching screens and/or inputs. Instead, the user may be presented with a rich experience of multiple content feeds across an ecosystem of content presented on a display or displays in the proximity of the user, which may include transitioning content from one display to another such as from a television monitor to a laptop display, or from one public monitor to another, as a user moves.

According to an example, to output content to a display, content from a first source and a second source, via a radio, is received. The first content and the second content are combined on a processor into a single stream and output to a display. In an example, the second content is received from a server and combined with the first content in response to a user in proximity to the display. In an example, the received second content is modified in response to a change in the user proximity.

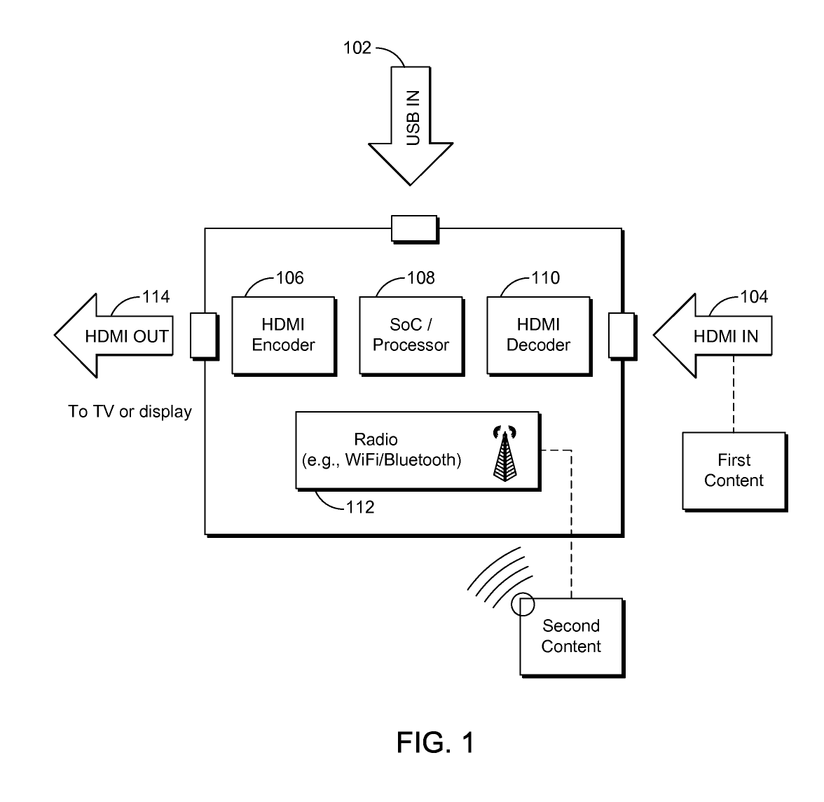

FIG. 1 illustrates a schematic representation of a device for receiving and combining content to be output to a display, according to an example of the present disclosure. In some examples, FIG. 1 may represent a standalone device such as a dongle or adapter that may be connected or coupled to another device, such as a television, monitor, computer, or other display (hereinafter “display”). In other examples, FIG. 1 may represent a device or hardware embedded into another device, such as in a display.

According to some examples, the device 100 comprises an input port 104 for receiving content such as video, audio, combined video and audio, or other data. Input port 104 may be a High-Definition Multimedia Interface (“HDMI”) port, or may receive other inputs such as Mobile High Definition Link (“MHL”), component, composite, DisplayPort, Mini DisplayPort, optical, or other wired or wireless inputs. Input port 104 may, in some examples, represent an internal display component for receiving a signal, such as in the example where device 100 is embedded in a display. In some examples, input port 104 receives a first content source, discussed in more detail below.

Device 100 may also comprise a video decoder 110 to decode content received from an input source, such as input port 104. Video decoder may be, for example, an HDMI decoder.

Device 100 may also comprise a radio 112 for receiving content, such as from a second content source discussed in more detail below. Radio 112 may represent a WiFi radio, a Bluetooth or low-energy Bluetooth radio, a Zigbee radio, a near-field communication radio, or other short or long-range radios for communicating with, e.g., a server as discussed in more detail below. Device 100 may also function as a bridge between multiple radio types or communication standards.

Device 100 may also comprise an integrated circuit or processor 108, which may include a system on a chip 108 (hereinafter “SoC” 108). SoC 108 may be used to combine the first and second content sources, or additional content sources, as discussed below in more detail

In an example, device 100 and/or SoC or related components may comprise a processor or CPU, a memory, and a computer readable medium. The processor, memory, and computer readable medium may be coupled by a bus or other interconnect. In some examples, the computer readable medium may comprise an operating system, network applications, and other applications related to sensing user proximity and/or processing video and/or audio.

Some or all of the operations set forth in the figures may be contained as a utility, program, or subprogram in any desired computer readable storage medium, or embedded on hardware, such as on device 100. In addition, the operations may be embodied by machine-readable instructions. For example, they may exist as machine-readable instructions in source code, object code, executable code, or other formats. The computer readable medium may also store other machine-readable instructions, including instructions downloaded from a network or the internet.

Device 100 may also comprise a video encoder 106, such as an HDMI encoder. Video encoder 106 may be used to encode content received from input port 104 or radio 112, or a combination of the content received from input port 104 and radio 112, as discussed in more detail below.

In some examples, device 100 may also comprise a video output port 114, such as an HDMI output port, to output the content from video encoder 106 to a display. In other examples, the content encoded in a video encoder 106 may be output directly to a display without use of a physical output port, such as in the case where the device 100 is embedded into a display.

In some examples, device 100 may also include a universal serial bus port 102 or other connector or bus. In some examples, port 102 may be used to provide power to device 100, such as in the case where device 102 is a dongle-type device connected to a display, if the device 100 is not receiving power from another source such as power over HDMI or MHL.

In other examples, port 102 may be used to expand the functionality of device 100, such as by connecting a camera for video conferencing or facial recognition, a motion or gesture sensor, or other sensor to extend the functionality of the device 100, including for sensing a user proximity as discussed below in more detail.

In some examples, the components of device 100 discussed above may be combined. For example, SoC 108 may also comprise a radio, such as a Bluetooth radio, on a single component or chip.

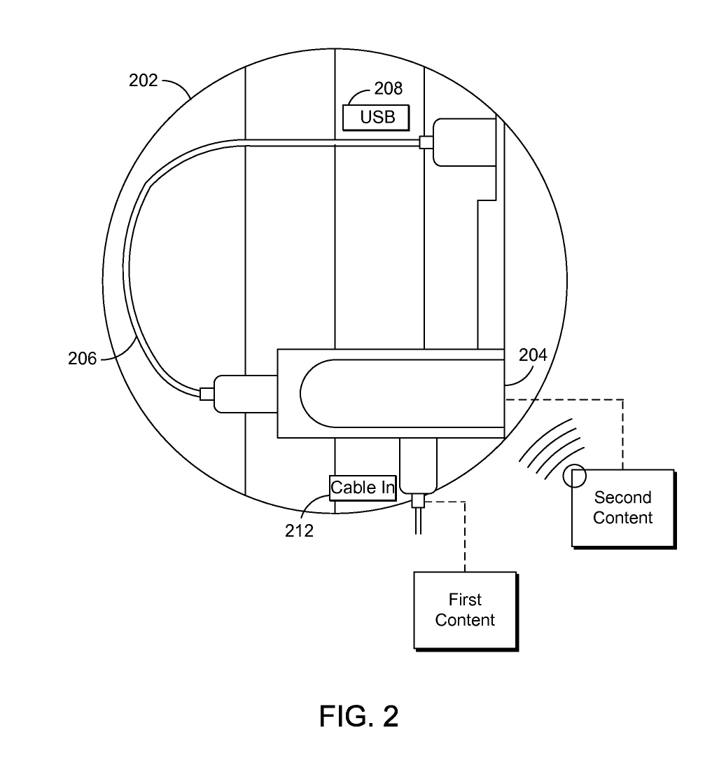

FIG. 2 illustrates the device of FIG. 1 when connected to a display, e.g., when device 100 is not embedded in a display, according to an example of the present disclosure. Device 100 may connect to a display 202 at a connection point 204, which may be an HDMI input port on the display 202. Device 100 may also receive an HDMI input from HDMI cable 212, and receive power from USB cable 206 at a connection point 208. As discussed above, various standards may be used for video, audio, data, and power transmission.

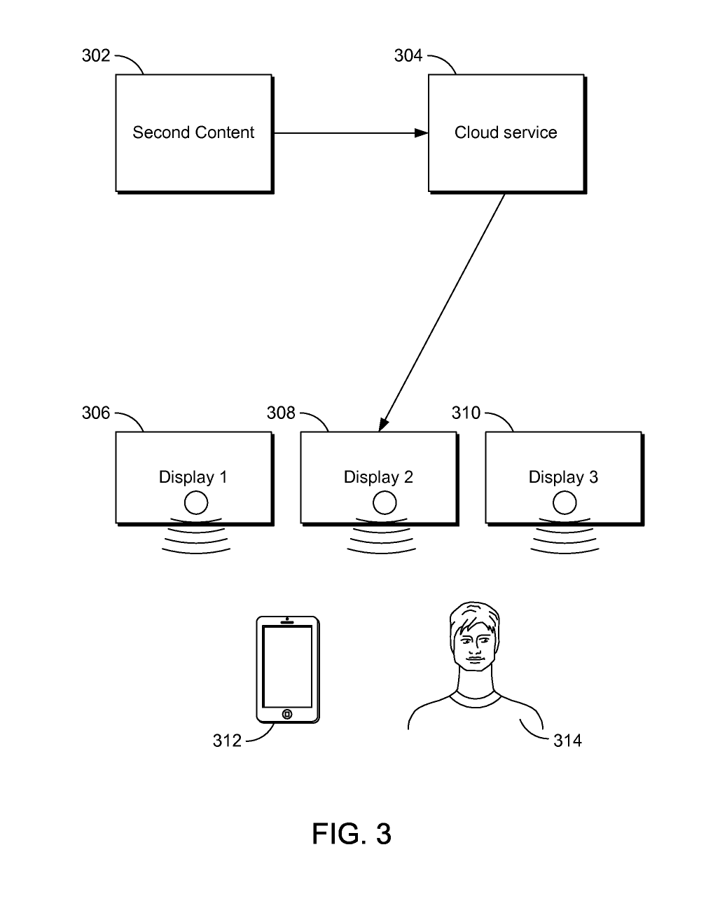

FIG. 3 illustrates a flow of content from a content source to displays, according to an example of the present disclosure. Content source 302 may be a third-party content source, such as a provider of video, audio, or other data. Content source 302 for example may be a push notification provider, a newsfeed provider, a short message service (“SMS”) provider, a camera feed provider, or a feed from one of many connected or networked devices, such as computers, servers, telephones or smartphones, home automation devices, appliances, or automobiles, for example. In some examples, such as in a home or enterprise setting, the content may be local content.

In some examples, content source 302 may transmit data directly to a user, such as to user 314, to a user's mobile device 312, or to a wearable device of the user 314 (hereinafter “user”). A mobile device may be, for example, a smartphone, a tablet, a laptop, or other mobile device associated with a user. A wearable device may be, for example, a digital watch, digital glasses, a fitness tracker, or other wearable device.

In other examples, content source 302 may transmit data to a remote server or cloud service 304 or other server, such as a local server that may be used in closed or private networks, such as within enterprise environments (hereinafter “server” 304). Server 304 may store the location of user 314 or proximity to a display (hereinafter “location” or “proximity”), which may include the location of a wearable device associated with the user, or server 304 may store the location or proximity data of the user's mobile device 312, as discussed in more detail below.

Displays 306, 308, and 310 may represent televisions, monitors, computer displays, or any other fixed or mobile display technology that is accessible or viewable by a user 314. In some examples, displays 306-310 may be devices in a user's home or workplace, while in other examples the displays may be in a public place, or some combination thereof, provided that the displays are capable of receiving content based on the location of user 314.

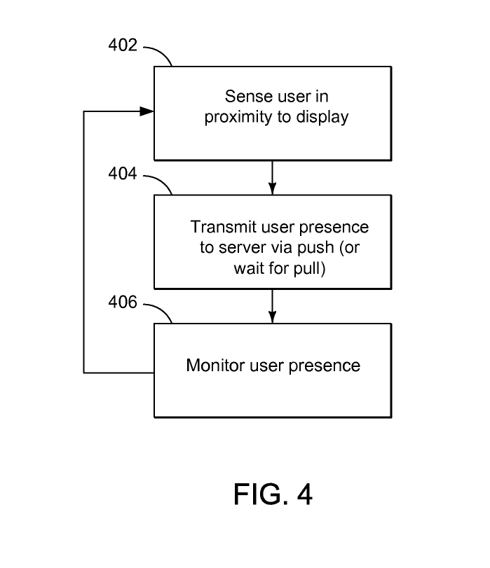

FIG. 4 illustrates a flow of a display sensing a user proximity, according to an example of the present disclosure. In block 402, a display 306-310 senses a user 314, which may include sensing a wearable device, or a mobile device 312 associated with the user in proximity to the display. Proximity may be sensed using radio 112, such as sensing the location of mobile device 312 using a Bluetooth radio, WiFi radio, GPS, or other locating-sensing device in combination with a known unique identifier associated with the user or a user device. In some examples, proximity may be sensed if the user 314 or mobile device 312 is within a certain range or threshold, which may be configurable.

Proximity may also be sensed using facial recognition technology, such as with a camera connected to a display 306-310, or a motion or gesture system connected to a device 100, which may be connected to a display 306-310. In some examples, sensors such as a camera may detect other user features such as a nametag on a uniform, or even specific body or facial features, or other features determined to be unique to an individual. Other technologies such as voice control or voice recognition may also be used to detect proximity. Various algorithms may also be employed to determine or predict how long a user will stay in a particular location, e.g., within proximity to a certain display.

In some examples, multifactor proximity sensing may be utilized based on multiple data sources. For example, the user's mobile device location may be paired with a facial recognition to determine reliably that the user, and not just the user's device, is in proximity to a display. Other combinations may also be employed, such as the location of a wearable plus an indication that the wearable is being worn or actively used by the user.

In block 404, the proximity information associated with a display 306-310 representing user presence near a display (processed and/or provided by device 100) is transmitted to server 304 based on, e.g., the event of sensing a user in proximity. In some examples, the information may be pushed to server 304, while in other examples server 304 may poll the displays 306-310 or device 100 to determine which display senses a user. In various examples, proximity information may include a unique identifier of the device and/or the user, geographic data, time data, or other data useful in identifying or locating the user, device, and/or display.

In block 406, the display 306-310 that sensed a user in proximity to the display may monitor the user presence. In some examples, display 306-310 may re-transmit the user presence on a continuous or periodic basis, e.g., by looping through blocks 402 and 404, while in other examples the display 306-310 may transmit only a change in a user proximity to server 304, such as when the user 314 is no longer sensed in proximity to the display 306-310. In examples where a user moves between one display to another, the flow of FIG. 4 may be carried out by other displays as the user changes location.

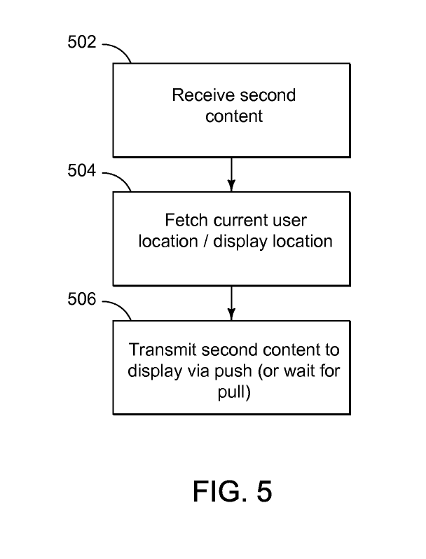

FIG. 5 illustrates a flow of a server receiving and transmitting content, according to an example of the present disclosure. In block 502, according to an example, server 304 receives content from content source 302, such as content from the push notification provider, newsfeed provider, short message service (“SMS”) provider, camera feed provider or security feed provider, or a feed from one of many connected or networked devices, as discussed above. The content may be associated with one user, a group of users, or all users associated with content source 302, server 304, or displays 306-310.

In block 504, server 304 fetches the location of a user or users in a group associated with the content received from content source 302. As discussed above with respect to blocks 402-406, the location of the user may be stored on server 304, or the location of the user may instead be represented by reference to a particular display or displays. In other examples, block 504 may be configured to fetch the location of all displays with which a user is associated, without respect to whether the user is currently in proximity to that display, as discussed below in more detail.

Block 504 may also comprise fetching the current user location or activity status from more than one source to provide “multi-factor” confirmation/sensing that a user is in proximity to a device. For example, a user may have a mobile device in proximity to a display, but not be present. In such cases, block 504 may fetch both the proximity information of the mobile device and also an activity or “in use” status from the mobile device, or proximity information from another device such as a wearable to increase the confidence that the user is present. Other technologies such as gesture or motion sensing may also be combined with proximity information to ensure that the user is in proximity to the display, especially in cases where privacy is an important factor.

In block 506, in an example, the content received from content source 302 is pushed to a display, such as the display in proximity to the user 314 or mobile device 312 at the time the content is received from content source 302, based on the fetch/lookup of block 504. In other examples, the content is pushed to all displays associated with a particular user, and the display (or device 100 connected to or embedded on the display) determines whether the user is in proximity to the display at that time. In various examples, content from server 304 may be pulled from the server 304, e.g., on a periodic basis, as opposed to pushed to the displays 306-310.

In some examples, the flow of blocks 502 through 506 may loop when a group of users is to receive content from the content source 302. In other examples, rules or filters may be applied in block 506 prior to transmitting the content received from content source 302.

For example, rules or filters may relate to time of day (so that certain content is not sent at certain times), whether content is relevant (e.g., not displaying automotive information when the user is at home), capability of a device (e.g., whether the device has multimedia or multiplexing capability), legal reasons (e.g., not transmitting video data to a user who is driving an automobile), power management or “green” rules (e.g., not transmitting video to a device in a low-power mode), or privacy reasons (e.g., not transmitting certain content if the user is in a certain location, or if a certain user is present such as a child or a non-employee, or if a blacklist or whitelist is triggered by a known user in proximity to a display, or if unknown users are in proximity to a display).

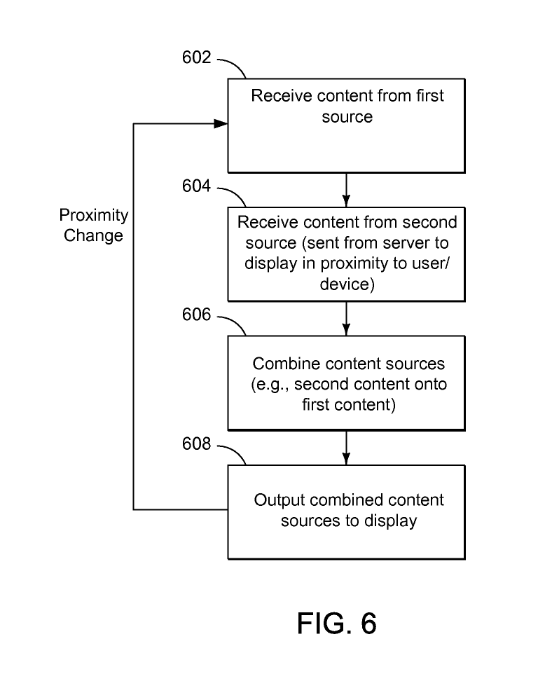

FIG. 6 illustrates a flow of receiving and combining content on a device, according to an example of the present disclosure. In block 602, content is received from a first source on the display and/or device 100. The first source may be received from the HDMI or MHL input port 104 discussed above. In some examples, the first source may be a video content provider such as a cable provider, a cable box, a digital video recorder, a physical media player such as a Blu-ray player, or other input.

In block 604, content is received from a second source, e.g., from server 304 as discussed above, comprising, e.g., a push notification, newsfeed, SMS, camera feed provider, or a feed from one of many connected or networked devices, also as discussed above. In some examples, content in block 604 is only received on the display and/or device 100 that reported a user proximity to server 304. In other examples, content in block 604, or a reference pointer to the content, is received on all displays and/or devices 100 associated with a user 314. In such cases, the display and/or device 100 determine whether the user is in proximity to the display prior to proceeding to block 606, and/or prior to downloading content if the content is referenced.

In block 608, content from the first source and second source is combined. In some examples, content from the second source is overlaid on the first source. For example, an SMS may be overlaid on a cable television feed. In some examples, combining the first and second content sources may include multiplexing.

In block 606, the combined content from the first and second content sources is output. In the case of an external device 100, the output step may include outputting to a video port, such as port 114. In the case where device 100 is embedded in the display, a direct output may be possible from device 100 to the display.

In some examples, block 608 may also include a time-based expiration for the content from the first or second sources. For example, block 608 may remove the second content source from the combined or multiplexed content after a pre-set interval, such as 30 seconds or another configurable or adaptive time interval.

In other examples, block 608 may change, modify, or remove the second content from the combined content source in response to or when the user 314 or device 312 is no longer in proximity to the display and/or device 100. In yet other examples, a predictive algorithm may be used to determine how long a user typically spends near a display and/or device 100 based on pattern detection or other inputs, such as the type, size, or length of the content payload.

In some examples, the flow of blocks 604 through 608 (and 502 through 506) may loop and/or update/refresh the display to which content is transmitted in block 604. For example, if a user is sensed in proximity to a first display, e.g., a television monitor at home, and the user transitions to a second display, e.g., an automobile display, server 304 will be updated with the current proximity/location data of the user and transmit the second content source to the automobile display in block 506. Block 608 may also comprise the rules/filters discussed above.

In some examples, block 608 may also accept a response or other feedback from a user. For example, a user may be prompted to respond to a text message or a dialog box or a prompt. A user response may be transmitted via, for example, radio 112 back to server 304 and/or content source 302.

In some examples, the device 100, display 306-310, mobile device 312 or wearable 314, may store a log or history of content, such as from the second content source, which may be accessible at a later time.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of outputting content to a display, comprising:
receiving first content from a first source;
receiving, via a radio, second content from a second source;
combining, on a processor, the first content and the second content into a single stream; and
outputting the single stream to the display,
wherein the second content is received from a server and combined with the first content in response to a user in proximity to the display, and
wherein the received second content is modified in response to a change in the proximity of the user.

2. The method according to claim 1, wherein the user proximity is sensed based on the location of a portable device associated with the user.

3. The method according to claim 1, wherein the user proximity is sensed based on a unique physical trait of the user.

4. The method according to claim 2, wherein the portable device is a mobile phone.

5. The method according to claim 2, wherein the portable device is a wearable computing device.

6. The method according to claim 1, wherein the second content is received from the server based on a rule.

7. The method according to claim 1, wherein the user proximity is confirmed via two-factor proximity sensing.

8. The method according to claim 1, further comprising transmitting a user response to the second content.

9. A computing device comprising:
a video decoder to receive content from a first source;
a radio to receive content from a second source;
an integrated circuit to combine the content from the first source and the content from the second source; and
a video encoder to output the combined content,
wherein the content from the second source is received from a server at the radio and combined with the content from the first source in response to a user being in proximity to the radio, and
wherein the content from the first source and the content from the second source are combined when a rule is satisfied.

10. The computing device according to claim 9, further comprising a universal serial bus input to receive content from a third source.

11. The computing device according to claim 9, further comprising a universal serial bus input to provide power to the computing device.

12. The computing device according to claim 9, wherein the rule comprises determining whether display of content from the second source is relevant to a user at a particular location.

13. The computing device according to claim 9, wherein the rule comprises one of a blacklist or a whitelist.

14. A non-transitory computer readable storage medium on which is embedded a
computer program, which when executed, causes a computing device to:
receive content from a content source intended for a group of users;
fetch the locations of the group of users associated with the content source; and
transmit the content from the content source to at least one display in proximity to the location of the users,
wherein the content from the content source is to be multiplexed with a video source on the at least one display, and
wherein the location of the users is updated.

15. The computer readable storage medium of claim 14, wherein the content from the content source multiplexed with the video source on the display is displayed for a period of time based on an adaptive time interval.
